(19) United States
(12) Patent Application Publication
(10) Pub. No.: US 2008/0067421 A1
(43) Pub. Date: Mar. 20, 2008

(54) Electron Beam Etching Apparatus and Method for the same

(76) Inventors: Kuei-Wen Cheng, Guanyin Township (TW); Jeng-Ywan Jeng, Guanyin Township (TW); Te-Fong Chan, Guanyin Township (TW)

Correspondence Address: HDSL, 4331 STEVENS BATTLE LANE, FAIRFAX, VA, 22033, US

(21) Appl. No.: 11/465,122

(22) Filed: Aug. 16, 2006

(51) Int. Cl. G21G 5/00

(52) U.S. Cl. 250/492.1

(57) ABSTRACT

A electron beam etching apparatus uses carbon nanotube as electron emitter. The electron beam etching apparatus includes a vacuum chamber, a cathode plate, an anode plate and a driver unit. The cathode plate and the anode plate are arranged in the vacuum chamber and parallel to each other. The cathode plate includes a plurality of cathode units, where each of the cathode units uses a carbon nanotube as an electron emitter. A gate conductive layer is provided atop the cathode unit. The anode plate includes a substrate and an etching target. The driver unit is electrically connected to the cathode unit and gate conductive layer. The driver unit controls the cathode unit through the gate conductive layer to generate electron beam for etching. The accuracy of etching process can be improved and the cathode unit has the advantage of replacement possibility.

### BACKGROUND OF THE INVENTION

1. Field of the Invention

The present invention relates to an etching apparatus, especially to an etching apparatus with cathode electron emitter.

2. Description of Prior Art

The current processing technology by electron beam lithography generally uses high-speed electron beam to bombard the substrate to be etched. The dynamic energy of the electron beam is converted to thermal energy for micro lithography or machining.

FIG. 1 shows a prior art electron beam lithography apparatus. In a vacuum environment, electron beam is generated by a cathode electron beam source and the electron beam is accelerated by an external voltage source of tens to hundreds KV for etching. The cathode electron beam source uses thermion electron source for thermally excitation. The electron beam is confined by a complicated confinement electrode after the electron beam passes anode. The electron beam is deflected by electromagnetic coil to a predetermined position. The high-speed electron beam is used to bombard a specific area. In the specific area, dynamic energy is converted to thermal energy to provide local high temperature in the specific area. The material in this area is damaged for lithography and patterned etch. FIG. 2 is schematic diagram for electron-beam hole dig. The electron beam can be further deflected by coil, or has translational movement by X-Y stage.

The electron beam lithography is a precise machining technology and the accuracy thereof is demanding. The conventional electron beam lithography uses thermion electron source, such as tungsten lamp, for thermally generate electron beam. The thermion electron source needs high energy and the component thereof cannot be replaced individually when the thermion electron source malfunctions. The thermion electron source should be entirely replaced and the material currently subjected to etch should be thrown away. This will impose inconvenience to process and the cost is increased.

Recently, a novel carbon nanotube (CNT) is developed to function as electron beam source and has been used as field emission electron source. Electron beam can be generated directly in vacuum environment by voltage difference. The electrical energy used by the carbon nanotube electron (CNT) beam source is greatly reduced because thermal energy is no longer needed. The CNT-based device has the advantage of high efficiency for electron beam source application. Moreover, the CNT electron beam source can be made into array type structure for further improvement.

### SUMMARY OF THE INVENTION

The present invention is to provide an electron beam etching apparatus using carbon nanotube as a cathode electron emitter to reduce cost and provide better etching quality.

Accordingly, the present invention provides an electron beam etching apparatus with carbon nanotube as electron emitter. The electron beam etching apparatus comprises a vacuum chamber, a cathode plate, an anode plate and a driver unit. The cathode plate and the anode plate are arranged in the vacuum chamber and parallel to each other. The cathode plate comprises a plurality of cathode units, where each of the cathode units uses a carbon nanotube as an electron emitter. A gate conductive layer is provided atop the cathode unit. The anode plate comprises a substrate and an etching target. The driver unit is electrically connected to the cathode unit and gate conductive layer. The driver unit controls the cathode unit through the gate conductive layer to generate electron beam for etching. The accuracy of etching process can be improved and the cathode unit has the advantage of replacement possibility.

### BRIEF DESCRIPTION OF DRAWING

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 shows a prior art electron beam lithography apparatus.

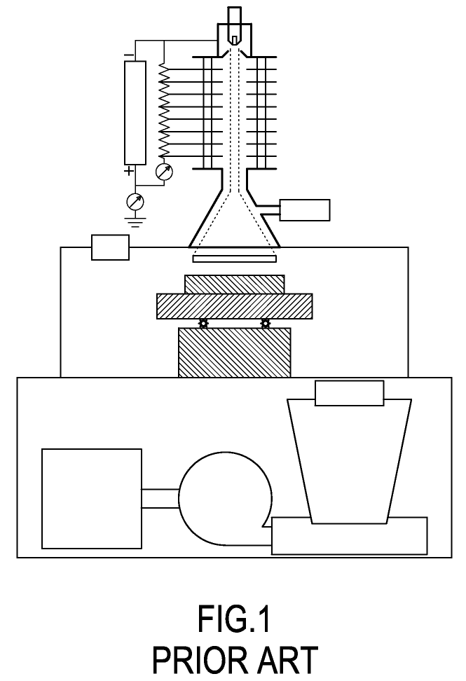

FIG. 2 is schematic diagram for electron-beam hole dig.

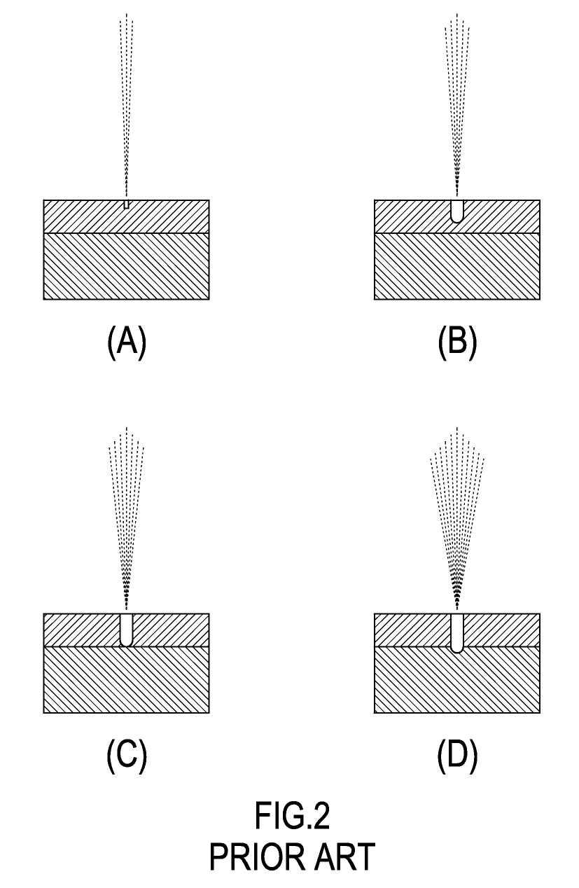

FIG. 3 is a schematic diagram of a preferred embodiment of the present invention.

FIG. 4 is a schematic diagram showing the operation of the present invention.

### DETAILED DESCRIPTION OF THE INVENTION

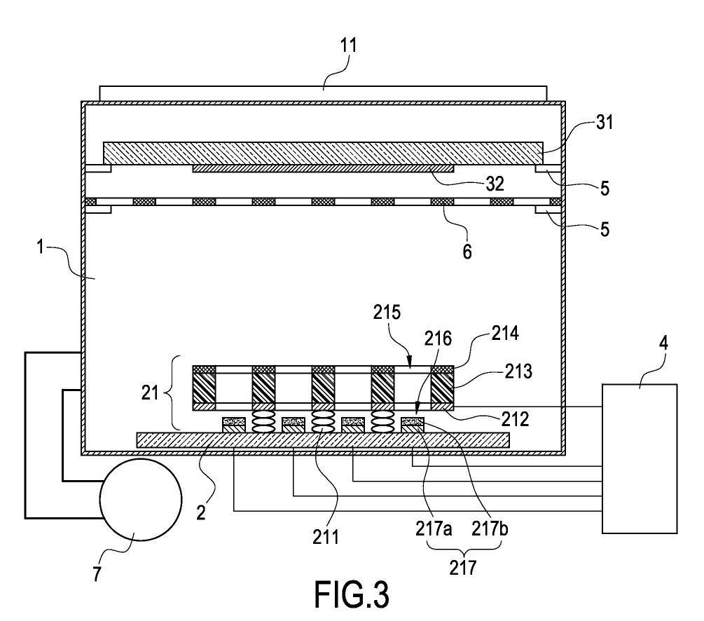

FIG. 3 is a schematic diagram of a preferred embodiment of the present invention. The electron beam lithography apparatus. The electron beam lithography apparatus of the present invention mainly comprises a vacuum chamber 1, a cathode plate 2, an anode plate 3 and a driving unit 4. The cathode plate 2 and the anode plate 3 are arranged in the vacuum chamber 1. The cathode plate 2 is made of glass material and comprises a cathode electron emitting unit 21. The cathode electron emitting unit 21 further comprises a first insulating layer 211 and a gate conductive layer 212 on the first insulating layer 211. A second insulating layer 213 is formed on the gate conductive layer 212 and a confinement layer 214 is formed on the second insulating layer 213, which is a metal mesh to provide a voltage for confining electron beam.

A plurality of through holes 215 are defined on the first insulating layer 211, the gate conductive layer 212, the second insulating layer 213 and the confine layer 214. The through holes 215 are arranged in array such that the cathode plate 2 is exposed through a concave region 216 inside the through holes 215. A cathode unit 217 is arranged in the concave region 216 and corresponding vertically to the gate conductive layer 212. The cathode unit 217 further comprises a cathode electrode 217a and a cathode electron emitter 217b, where the cathode electrode 217a is arranged on the cathode plate 2 and the cathode electron emitter 217b is connected to the cathode electrode 217a. The cathode electron emitter 217b is composed of carbon nanotube to form the cathode electron emitting unit 21.

In the shown preferred embodiment, the anode plate 3 comprises an anode substrate 31 to be etched. The anode substrate 31 is a conductor and parallel to the cathode plate 2. The anode substrate 31 is fixed by an insulating support 5 on both sides thereof. An etch target 32 is placed at surface of the anode substrate 31 to defined an etching pattern. An anode mesh 6 is placed in front of the etch target 32 and is supported by the insulating support 5 on both sides thereof. The anode mesh 6 provides a high voltage to accelerate the electron beams.

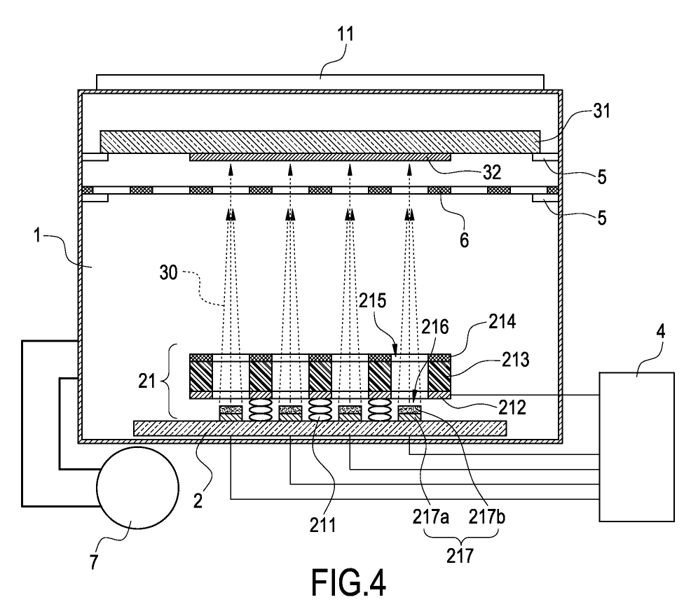

With reference to FIG. 3, the driver unit 4 is arranged outside the vacuum chamber 1, and is electrically connected to the cathode unit 217 of the cathode plate 2 and the gate conductive layer 212, whereby the cathode unit 217 of the cathode plate 2 can be controllable emitter unit. The driver unit 4 supplies voltages of high/low levels to the cathode unit 217 and the gate conductive layer 212 to form an electrical field therebetween, whereby the cathode electron emitter 217b can generate electron beam 30 as shown in FIG. 4. An openable cover 11 is provided atop the vacuum chamber 1 and a vacuum pump 7 is provided outside the vacuum chamber 1 to keep a vacuum state in the vacuum chamber 1 during etching.

FIG. 4 is a schematic diagram showing the operation of the present invention. When the substrate 31 is placed into the vacuum chamber 1, the vacuum pump 7 provided outside the vacuum chamber 1 operates to keep a vacuum state in the vacuum chamber 1 during etching. Afterward, the electron beam 30 is used to etch. The cathode unit 217 is controlled by the driver unit 4 and the driver unit 4 provides voltage difference to generate an electric field between the cathode plate 2 and the gate conductive layer 212. Therefore, the cathode electron emitter 217b can generate electron beam 30.

The electron beam 30 is confined by the confinement layer 214 and is accelerated by the anode mesh 6 in front of the substrate 31 to etch the target 32. The driver unit 4 controls the electron beam emitted from the cathode electron emitter 217b to form desired etching pattern on the target 32, and the etching depth is controlled by the voltage difference of the driver unit 4. Therefore, desired etching pattern can be formed on the substrate 31. To provide sufficient voltage difference between the cathode plate 2 and the anode plate 3, the separation between the anode mesh 6 and the anode plate 2 can be at least 100 mm or more.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. An electron beam etching apparatus, comprising
a vacuum chamber;
a cathode plate arranged in the vacuum chamber and comprising a plurality of cathode units and a gate conductive layer, the cathode units being vertically arranged to the gate conductive layer;
an anode plate arranged in the vacuum chamber and parallel to the cathode plate and corresponding to the cathode unit on the cathode plate; the anode plate further comprising a substrate and an etching target arranged on inner side of the substrate
a driver unit arranged outside the vacuum chamber and electrically connected to the cathode unit and gate conductive layer.

2. The electron beam etching apparatus as in claim 1, wherein a cover is provided atop the vacuum chamber.

3. The electron beam etching apparatus as in claim 1, wherein the vacuum chamber is connected to a vacuum pump.

4. The electron beam etching apparatus as in claim 1, wherein the cathode unit further comprises a cathode electrode arranged on the cathode plate and the cathode electrode is connected to a cathode electron emitter.

5. The electron beam etching apparatus as in claim 4, wherein the cathode electron emitter is composed of carbon nanotube.

6. The electron beam etching apparatus as in claim 1, further comprising a first insulating layer provided between the gate conductive layer and the cathode plate, a second insulating layer arranged atop the gate conductive layer; a confinement layer atop the second insulating layer; a plurality of through holes defined atop the first insulating layer, the gate conductive layer, the second insulating layer and the confinement layer; a concave region inside the through holes to expose the cathode plate, wherein the cathode unit is provided in the concave region.

7. The electron beam etching apparatus as in claim 6, wherein the confinement layer is a metal mesh.

8. The electron beam etching apparatus as in claim 6, wherein the through holes are arranged in array.

9. The electron beam etching apparatus as in claim 1, wherein supports are provided on both sides of the anode plate.

10. The electron beam etching apparatus as in claim 9, wherein the supports are insulating supports.

11. The electron beam etching apparatus as in claim 1, wherein the substrate is made of a conductive material.

12. The electron beam etching apparatus as in claim 1, further comprising an anode mesh in front of the etching target.

13. The electron beam etching apparatus as in claim 12, wherein supports are provided on both sides of the anode mesh.

14. The electron beam etching apparatus as in claim 12, wherein the distance between the anode mesh and the cathode plate is equal to 100 mm.

15. The electron beam etching apparatus as in claim 12, wherein the distance between the anode mesh and the cathode plate is more than 100 mm.

16. An electron-beam etching method, comprising the steps of:
providing a fixed etching target;
providing a cathode plate corresponding to the etching target and comprising a plurality of controllable cathode electron emitters;
exciting the cathode electron emitters to emit electron beam toward the etching target to etch a pattern on the anode target.
